(19) United States
(12) Patent Application Publication
(10) Pub. No.: US 2004/0236568 A1
(43) Pub. Date: Nov. 25, 2004

(54) Extension of m3u file format to support user interface and navigation tasks in a digital audio player

(76) Inventors: Newton Galileo Guillen, Carmel, IN (US); Lisa Renee Johnson, Indianapolis, IN (US); Sin Hui Cheah, Carmel, IN (US)

Correspondence Address: Joseph S Tripoli, Thomson Multimedia Licensing Inc, PO Box 5312, Princeton, NJ, 08543-5312, US

(21) Appl. No.: 10/488,984

(22) PCT Filed: Sep. 6, 2002
(86) PCT No.: PCT/US02/28485

Related U.S. Application Data
(60) Provisional application No. 60/318,721, filed on Sep. 10, 2001.

(51) Int. Cl. G10L 19/00

(52) U.S. Cl. 704/201

(57) ABSTRACT

A digital audio player and a data structure and method for providing an audio playlist. The data structure includes a playlist record for each audio data file, each playlist record including a file pointer segment and an information segment having a plurality of content information fields and at least one indexing information field. A method of browsing audio file content information in an audio data player having a user interface includes providing at least one playlist including records stored in a predetermined sequence and including an information segment including content information fields and indexing information fields, outputting the content information fields to the user interface, receiving a playlist navigation signal from the user interface, and in response to the playlist navigation signal, using the indexing information fields to locate and output the content information fields for another record, the records related by the predetermined sequence and the navigation signal.

### BACKGROUND OF THE INVENTION

1. Field of the Invention

The present invention relates to an apparatus and a method for processing digitally encoded audio data, and in particular, to a method, an apparatus, and a data structure related to an audio data file playlist.

2. Description of the Related Art

The use of portable audio data players capable of playing digitally encoded audio data has become commonplace. In particular, relatively small handheld devices that can process digitally encoded audio data stored on solid state memory devices have become popular. Additionally, as demand has increased for higher data storage capacity in portable audio data players, another generation of players that include miniaturized high capacity hard drives has been developed and is gaining popularity.

In an audio data player, the digital audio data is loaded into a data storage device by first downloading the data to a PC from an audio CD, the Internet, or another digital audio device. The data is then usually compressed according to a selected encoding format and loaded into the data storage device associated with the audio data player.

The audio data is decompressed/decoded by the audio data player during playback according to the selected encoding format. A variety of encoding formats for compressing and decompressing audio data is available. As used hereinafter, the term encoding format refers to any encoding/decoding scheme that specifies the syntax and semantics of a compressed bitstream and how the bitstream must be decompressed for reproduction. Such encoding formats include, but are not limited to, MP3 and MP3 Pro.

For MP3 encoded audio data files, the data file is prepended or appended with a special set of frames called an ID3 tag. The ID3 tag contains descriptive text and other data relevant to the audio data file. For example, the tag may include title, artist, album, year, comments, and genre. ID3 tag information is useful for searching, sorting, and selecting specific audio data files based on the information contained in the ID3 tag. Because ID3 tag information is often stored as textual characters, the information can be displayed on the display screen of an audio data player.

Most PC-based audio data file management programs allow the user to create and edit playlists that can then be downloaded to a portable audio data player and used for playing a select sequence of audio data files. One such form of playlist typically associated with MP3 audio data files is known as an M3U playlist. An M3U playlist consists simply of a text file containing a sequential list of paths or locations of data audio files included in the playlist. Thus, a playlist created on a PC and downloaded to an audio data player may be used to selectively play a sequence of audio data files that are contained in the data storage of the audio data player. However, the M3U file format includes only the file location or path information and a comment field. Thus, the M3U file format allows the player to playback a predetermined sequence of audio data files, but does not contain other audio data file information such as the information contained in an ID3 tag of an MP3 audio data file.

PC-based audio data file management programs also allow the user to sort available audio data files by their content, such as by ID3 fields for MP3 audio data files. PCs generally have the processing power to quickly extract the content description information from the audio data files and also have the necessary memory to store this information and display it in a timely manner to the user. However, such processing is generally not practical in non-PC-based audio data players, particularly portable or hand-held players, which have limited processing power and memory. This limitation is especially acute in audio data players having high-capacity data storage that is able to store several hundred or thousand audio data files. Therefore, browsing available audio data files in various sequences according to their ID3 information has not been available in non-PC-based audio data players.

### BRIEF SUMMARY OF THE INVENTION

The present invention addresses some of the above-noted limitations of audio data players, particularly handheld audio players, by providing a data structure for audio playlist records having both content information and indexing information. The method of browsing audio data file content information utilizes the playlist's content and indexing information. The resulting audio data player having a microcontroller coupled with data storage and an audio decoder for processing encoded audio data files and audio playlist files may then quickly and conveniently allow a user to review, select, and modify audio file playlists and save those modified playlists on other systems, e.g., a user's PC.

In particular, the present invention provides a data structure that is an extension of the M3U file format used to store audio playlists. The data structure according to the present invention uses an M3U comment field format to add audio content information descriptive of the content of the audio data file, and indexing information indicating the relative location of related playlist records. Content information can include, for example, ID3 tag information found in MP3 files. Additionally, the data structure can be sorted by one or more of the content information fields.

The present invention also provides a method of adding to an audio playlist content and indexing information for each playlist record. The playlist files can be used by an audio data player to later access audio content information for all available audio data files in data storage without having to again access the data directly from individual audio data files. Additionally, multiple audio playlists can be created and stored, each being sorted by a different content information field, for example, artist, album, title, genre, etc.

The present invention also provides a method of browsing audio data file content information in an audio data player by providing a playlist having records stored in a predetermined sequence and including a content and indexing information segment. The content information includes fields descriptive of the content of the related audio data file and the indexing information includes fields providing the relative location of related playlist records. For example, a playlist sorted by genre may for a single genre include several albums by a particular artist. The indexing information provides quick and efficient navigation among records that are related, for example, by genre, artist, and album. Additionally, the content information fields may be provided to an audio data player output device, for example a display, and navigation to the content information of other playlist records may be provided in response to a playlist navigation signal and guided by the indexing information fields.

The present invention also provides an audio data player having a microcontroller coupled with data storage capable of storing audio data files and playlist files and having software capable of reading the playlist file records and outputting a navigable list of at least a portion of content information fields of the playlist records according to a predetermined sequence.

The audio data player generally includes a microcontroller coupled with a user interface, data storage, buffer memory, and an audio decoder. The user interface includes an LCD and a keyboard having various multi-way and multi-function switches. The audio data player also provides a universal serial bus (“USB”) port for connection to a PC or other USB-equipped device. By connecting the audio data player to a PC via the USB port, audio data files and audio playlists may be downloaded to the audio data player and stored into data storage. In one embodiment, the data storage comprises a 10 GB hard drive; however, other moving data storage media or solid state memory devices, such as flash memory cards, may also be used. In this embodiment, the user interface provides menu driven selection, sorting, and playback of audio data files. Additionally, during playback of an audio data file, the LCD displays ID3 tag information such as title, artist, album, and genre. The LCD screen may also display other information such as elapsed playback time, volume level, and preset DSP mode.

The disclosed embodiment of the audio data player is a portable handheld unit having a rechargeable battery, 5 volt DC input, headphones output port, and line out port. Therefore, the audio data player may be used for portable applications using headphones, or for fixed applications using AC power and headphones or another audio device.

In one form thereof, a data structure stored on a computer-readable medium is disclosed including a playlist record for each audio data file, each playlist record including a file pointer segment, each playlist record including an information segment having a plurality of content information fields descriptive of the content of the audio data file and including at least one indexing information field indicating the relative location of related playlist records, and the playlist file including a data header indicating a first content information field upon which the playlist records are sorted.

In another form thereof, a method is disclosed for adding to an audio data file playlist content and indexing information for each playlist record by locating content information descriptive of the content of each audio data file, determining for each playlist record indexing information providing the relative location of related playlist records, and formatting the content and indexing information for storage in the playlist.

In yet another form thereof, in an audio data player having a user interface including an output device and a user input, a method is disclosed for browsing audio data file content information by providing at least one playlist including at least a first and second record relating to audio data files available for playback, each record stored in a predetermined sequence including a content and indexing information segment, the content information including fields descriptive of the content of the related audio data file, and the indexing information having fields providing the relative location of related playlist records, outputting via the output device at least one of the content information fields for at least a first record, receiving a playlist navigation signal from the user input, and in response to the playlist navigation signal, using at least one of the indexing information fields to locate and output at least one of the content information fields of at least a second record, the second record related to the first record by the predetermined sequence and the navigation signal.

In another form thereof, an audio data player is disclosed comprising a microcontroller coupled with data storage capable of storing audio data files and playlist files, the audio data files each having attributes descriptive of the audio content of each audio data file, the playlist files including records for each of at least a portion of the audio data file, the records in a predetermined order based on at least one of the attributes, the records including content information fields storing the attributes of each audio data file, and indexing information fields indicating the relative location of related playlist records, and the microcontroller having software capable of reading the playlist records and outputting a navigable list of at least a portion of the content information fields according to the predetermined order.

Advantageously, the disclosed data structure supports and enhances user interface and navigation tasks in viewing and selecting audio data files stored on a high-volume data storage device. Additionally, the present invention allows non-PC-based audio data players with limited processing power and memory to provide sophisticated user interface and navigation features that allow players to display the audio data files stored in data storage sorted by content information such as ID3 fields.

A further advantage of the present invention is that non-PC-based audio data players may access the audio content information for all audio data files stored in data storage without having to read the data directly from each audio file. Therefore, the user may quickly and easily sort and display the stored audio data files in a specified manner.

Another advantage of the present invention is generating a playlist file in an audio data player that contains content information and indexing information for the purpose of reducing memory and processing power requirements, and thus the cost of producing audio data players. Yet another advantage of the present invention is that the audio playlist files maintain compatibility with standard M3U playlist files and thus may be used with other PC and non-PC-based applications.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of a portable audio data player according to the present invention;

FIG. 2 is a top view of a portable audio data player according to the present invention;

FIG. 3 is a back view of the portable audio data player of FIG. 2;

FIG. 4 is a right side view of the portable audio data player of FIG. 2;

FIG. 5A is a plan view of the main sort-by menu displayed on the audio data player of FIG. 2;

FIG. 5B is a plan view of the artist menu displayed on the audio data player of FIG. 2;

FIG. 5C is a plan view of the album menu displayed on the audio data player of FIG. 2;

FIG. 5D is a plan view of the song or track menu displayed on the audio data player of FIG. 2;

FIG. 6 is a schematic diagram of a data structure for a playlist according to the present invention;

FIG. 7 is a flowchart diagram illustrating the steps for adding content and indexing information to an audio playlist file according to the present invention; and

FIG. 8 is a flowchart diagram illustrating the steps for creating an audio playlist file according to the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates one embodiment of the invention, in one form, and such exemplifications are not to be construed as limiting the scope of the invention in any manner.

### DETAILED DESCRIPTION OF THE INVENTION

The embodiment disclosed below is not intended to be exhaustive or limit the invention to the precise form disclosed in the following detailed description. Rather, the embodiment is chosen and described so that others skilled in the art may utilize its teachings.

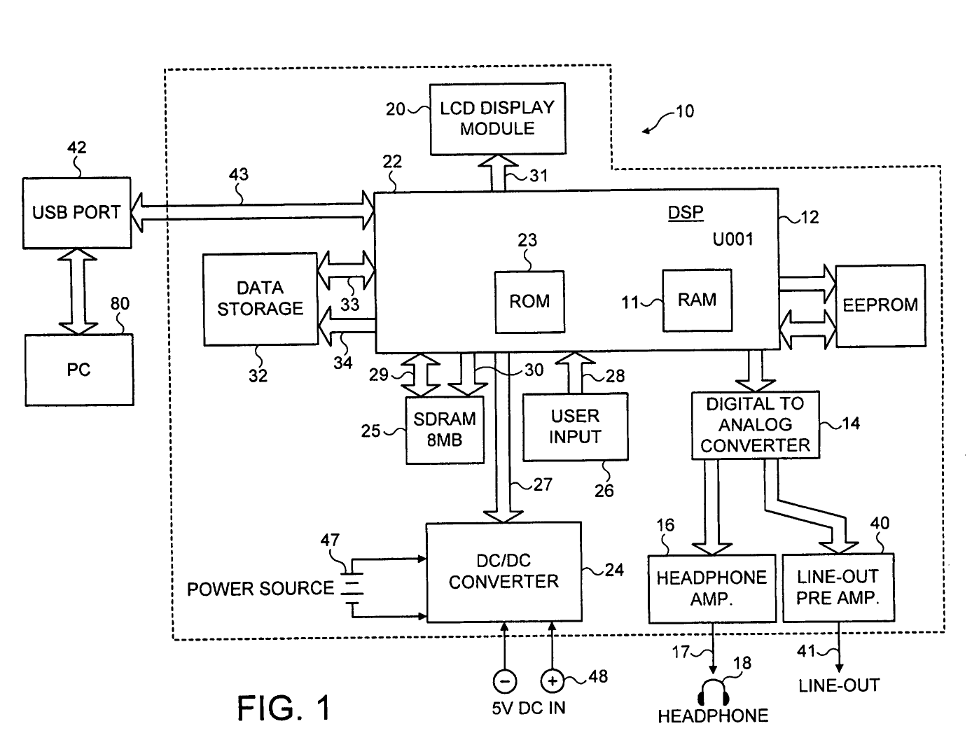

FIG. 1 shows a block diagram of portable audio data player 10 according to the present invention. The general arrangement and operation of the various elements are described hereinbelow. However, the details of the various elements of audio data player 10 are well known to those skilled in the art and will not be discussed here. Audio data player 10 comprises DSP 12 that controls the various elements and the overall operation of audio data player 10, including transferring data from data storage 32, through buffer memory 25, and decoding compressed audion files. DSP 12 includes a suitable amount of memory 23 and 11, for storing various instruction sets and programs for controlling the operation of audio data player 10.

DSP 12 may be programmed to perform a variety of signal processing functions during playback of a selected audio data file. In this case, the functions that DSP 12 performs during playback include, but are not limited to, decoding audio data files, volume control, digital sound equalization, and sample conversion. In that regard, DSP 12 includes onboard memory 11, wherein the decoder files, audio data files, equalizer mode selection, and various other required data are loaded during playback.

The decoder files comprise programs that control the decoding operations of DSP 12 and the audio data files include data associated with the audio content. Both the audio data files and the decoder files are stored in data storage 32. The decoder file including the programs are transferred to DSP memory 11 from data storage 32.

Audio data and decoder programs stored in data storage 32 may be encrypted, requiring that decoding program files and audio data files be decrypted by DSP 12 using one or more decryption keys. The decryption keys may also be stored in data storage 32 and may be security linked to the particular storage device or some other coded component of audio data player 10 so that audio data files encrypted for use on a particular audio data player may only be decrypted and played by that particular audio data player.

As a selected audio data file is decoded, DSP 12 provides the decoded data stream to digital to analog converter 14. D/A converter 14 converts the digital output of DSP 12 into an analog signal and provides the analog signal to headphones amplifier 16 and lineout pre-amp 40. The analog signals are amplified and provided to lineout jack 41 and headphones jack 17, both disposed on housing 13 of audio player 10.

Audio player 10 is adapted to operate with data storage 32. In this embodiment, data storage 32 is a moving data storage device, specifically a hard drive, that can be used to store various data files, including encoded audio data files, decoder files for controlling the decoding operation of DSP 12, playlist files, and computer data files, such as, for example, word processing files, presentations, and spreadsheets. A large amount of data can be readily transferred between data storage 32 and DSP 21 through data bus 33. Buffer memory 25 operates as a circular data buffer to prevent interruption of audio playback caused by a skip or other similar moving data storage device data transfer delays. Using the present invention, decoder files, playlists, and relatively large amounts of audio data may be stored on data storage 32.

In accordance with the present invention, audio data files are loaded into data storage 32 via USB port 42 from a PC, or other similar device, using music management software that encodes the audio data files in accordance with a selected encoding format, such as MP3, or MP3 Pro, and then stores the encoded data files. Such music management software is implemented using programming methods known in the art. The music management software transmits the audio data files and appropriate decoder files to audio data player 10 across data buses 43 and 33 and into data storage 32. The music management software also generates, and modifies as necessary, a system configuration file and a file attribute table to provide information regarding the various data files and decoder files stored in data storage 32. Using the configuration file and the file attributes table, audio data player 10 is able to display audio data files sorted by various groupings on display 21, determine the correct encoding format for each audio data file, and download the appropriate decoder file for each content file in response to a user selection.

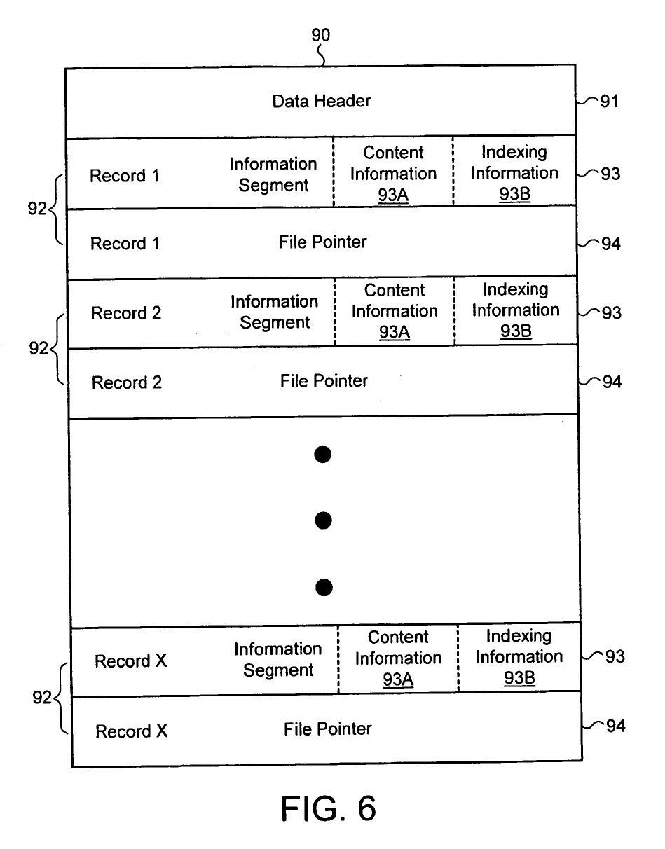

FIG. 6 is a schematic diagram of an exemplary embodiment of data structure 90. Data structure 90 generally comprises data header 91, individual audio data file records 92, each record 92 including information segment 93 and file pointer 94. In the exemplary embodiment, data structure 90 is an audio playlist file that includes an M3U format. Data header 91 includes information for identifying the file and of relevance to all the individual records 92. For example, in the exemplary embodiment, the data header has the following format:

#EXTLYRAM3U<Sorting_Field>Vx.xx

The “#EXTLYRAM3U” keyword is used to identify the file as a LyraHD system playlist file intended for use with the exemplary embodiment of audio data player 10. The Sorting Field is enclosed by the “<” and “>” characters and contains the name of the content information field, for example, an ID3 tag field, used to sort records 92 in playlist file 90. The version of the LyraHD playlist follows the Sorting_Field and is in the form of Vx.xx where x.xx represents a 3 digit decimal version number. The applications that utilize the extended M3U file format may be configured to recognize the specific order of content and indexing information shown below.

Information segment 93 includes a plurality of content information fields 93A descriptive of the content of the audio data file, for example, ID3 tag fields, and also includes at least one indexing information field 93B indicating the relative location of related playlist records 92. Table 1 includes the content information fields 93A included in the exemplary embodiment and Table 2 includes the indexing information fields 93B included in the exemplary embodiment.

TABLE 1

| Field Name | Description |
|---|---|
| audioinfoKeyword | #EXTLYRAINF indicates the start of a |
| | two-line audio file record |
| numberOfLevelsInTrackInfo | The number of sorted levels in a particular |
| | playlist file |
| trackIndexInPlaylist | Indicates the order of the current record in |
| | the playlist |
| charsInCurrentTrackInfo | The number of characters in the current |
| | two-line audio record |
| albumInfoField | Album name |
| artistInfoField | Artist name |
| titleInfoField | Title |
| genreInfoField | Genre |
| trackNumberInfoField | Track number in a given album |
| genericInfoField | For future expansion |

TABLE 2

| Field Name | Description |
|---|---|
| tracIndexInLevel[level] | The order of a specific entry in the current |
| | sorting level |
| totalTracksInLevel[level] | The total number of different entries in the |
| | current sorting level |
| charsToTopOfLevel[level] | Number of characters from the end of the |
| | current record to the start of the first record in |
| | the current sorting level |
| charsToNextTrackInSameLevel[level] | The number of characters from the end of the |
| | current two-line record to the start of the first |
| | record in the next entry that is in the same |
| | sorting level and shares the same parent |
| | sorting level |
| charsToPreviousTrackInSameLevel[level] | The number of characters from the end of the |
| | current two-line record to the start of the first |
| | record in the previous entry that is in the |
| | same sorting level and shares the same parent |
| | sorting level |

Playlists 90 are sorted by at least one of the content information fields 93A of Table 1. However, the playlist 90 may also have multiple sorting levels and thus each record 92 may have several levels of index information fields 93B shown in Table 2. For example, playlist 90 sorted by artist may contain three sorting levels. The first sorting level refers to all audio data files sorted by artistInfoField. The second sorting level groups all files by a particular artist and sorts each group by albumInfoField. The third sorting level groups all files by album and sorts each group by either the value of the trackNumberInfoField or the value of the titleInfoField. Although the exemplary embodiment includes five sorting levels, any number of content information and indexing information fields and sorting levels may be used by the present invention.

In the exemplary embodiment, the data structure of FIG. 6 includes data written in the typical M3U format. Specifically, file pointer segment 94 stores data in accordance with typical M3U format and may provide absolute or relative path locations of the audio data file associated with playlist record 92. In the exemplary embodiment, a relative path location is provided so that playlist 90 is transportable between devices. Information segment 93 containing content information fields 93A and indexing information fields 93B that include an M3U comment format, specifically the first character of the line being a “#” character. Additionally, data header 91 also includes an M3U comment format.

Music management software that encodes and transmits the audio data files may also create and transmit playlist files 90 into data storage 32 via USB port 42 from a PC or other similar device. Such playlists generally use an M3U format that is similar to the data structure disclosed above and in FIG. 6; however, the data structure likely consists of records 92 containing only file pointer segments 94, and thus lack information segment 93 as disclosed above.

The present invention includes a method of adding information segment 93 to a standard M3U or other playlist file. While the inventive method may be executed in audio data player 10, a PC, or another data device, the exemplary embodiment includes software for adding information segment 93, including content information fields 93A descriptive of the content of each audio data file and indexing information fields 93B providing the relative location of related playlist records, to audio playlist files 90 in audio data player 10.

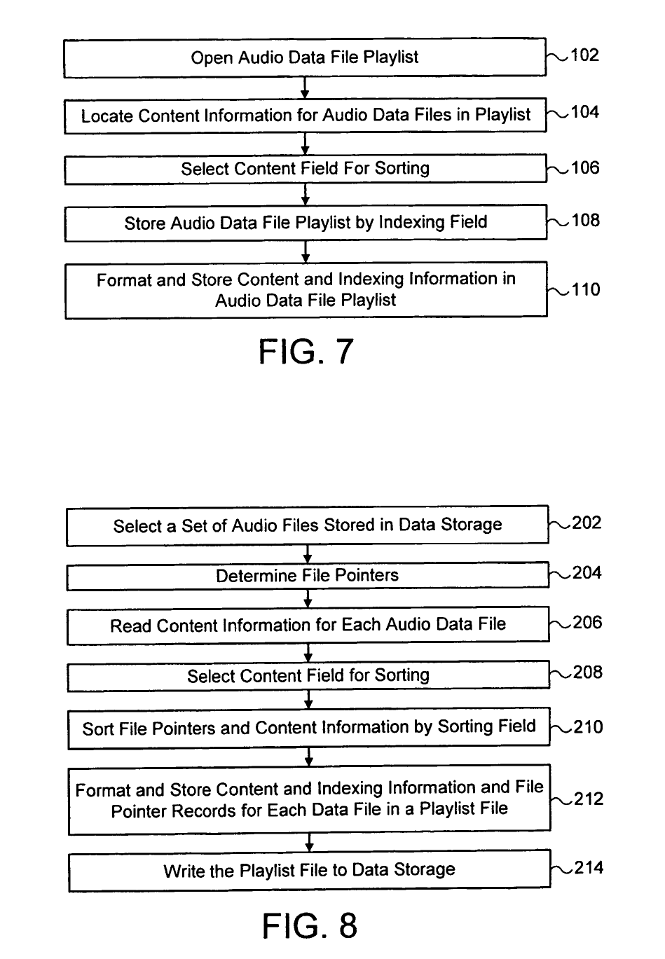

FIG. 7 shows a flowchart illustrating the steps for adding content and indexing information to a playlist in an audio data player 10 according to the present invention. The steps may be initiated manually by user selection via user input 26, or may be automatically initiated by the receipt of a new playlist into data storage 32 via USB port 42, or some other change in the files stored in data storage 32. In the exemplary embodiment, a software module is provided for executing the steps of FIG. 7 in audio data player 10.

In step 102, an audio data file playlist 90 located in data storage 32 is opened. For each record 92 of playlist 90, step 104 locates content information for the associated audio data file that record 92 refers to. For example, using a relative location stored in record 92 for the audio data file, audio data file located in data storage 32 may be opened and the content information read. Content information includes attributes or other descriptive information of the audio stored by the audio data file. In the exemplary embodiment, the content information includes ID3 tag information from MP3 audio data files. Alternatively, content information for an associated audio data file may be downloaded from a connected PC, the Internet, user input 26, or another source of data information.

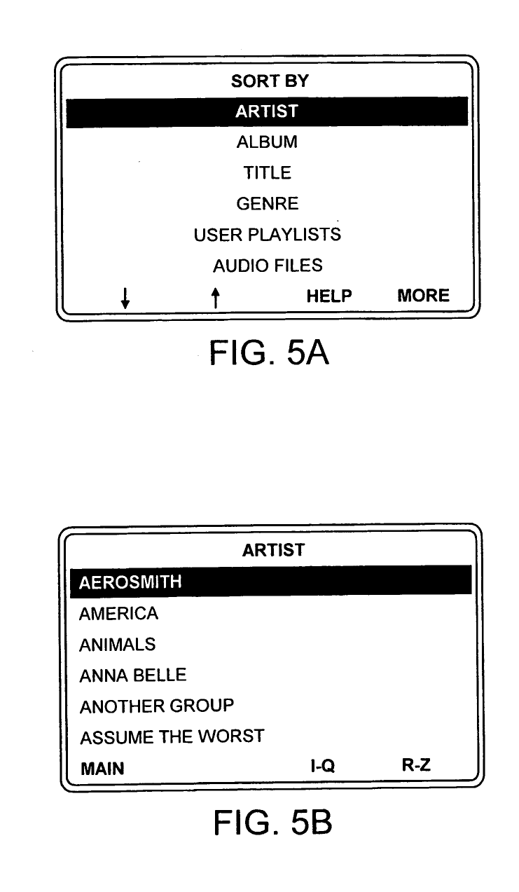

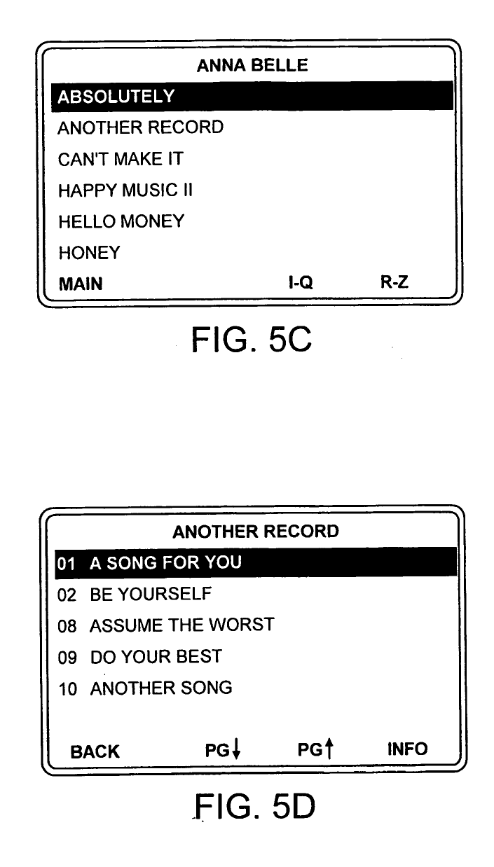

In step 106, a content information field 93A for sorting playlist records 92 is selected. The selection of which content field on which to sort playlist 90 may be specified by the user via user input 26 or by software selection based on playlists generated to support display and browsing of audio data files on audio data player 10. For example, referring to FIG. 5A, each of the main sort-by menu categories are supported by a playlist sorted by the content category or field listed. For example, a playlist sorted by each of artist, album, title, genre, and file names.

After the content information field 93A for sorting playlist file 90 is selected, in step 108 playlist 90 is sorted and stored. Sorting may comprise more than one sorting level to support grouping and quick and efficient browsing of related audio data file records within the sorted content information field 93A. For example, a playlist file that is sorted by artist may include a second sorting level sorted by albums within each particular artist and a third sorting level sorted by track number or title for each particular album. The additional sorting levels and the supporting indexing information fields 93B support browsing of playlist 90 and audio data file content information without the need to access individual audio data files. In step 110, the selected audio data file playlist 90 is rewritten using the formatted content information 93A and indexing information 93B and sorting order specified by the user or the software.

Indexing information comprises the fields 93B disclosed in Table 2 above and provides quick and memory-efficient browsing of related playlist records 92. The indexing information fields 93B support display groupings for browsing and navigation of various sorting levels, for example, those shown in FIGS. 5A through 5D. Referring to FIG. 5B, a playlist sorted by artist may include a second sorting level and associated indexing information 93B for each album of each artist, for example, the albums shown in FIG. 5C associated with artist Anna Belle. Additionally, playlist 90 indexing information 93B may include a third sorting level of tracks or songs for each album as shown in FIG. 5B for the album Another Record by artist Anna Belle.

Indexing information 93B defines the number of records included at a given sorting level and the relative location of next and previous records in the same sorting level and the relative location of the first record in the current grouping of the current sorting level. The indexing information fields 93B shown in Table 2 are exemplary, and may include other fields that provide browsing and navigation of the sorted playlist 90 with minimal memory and record 92 search time.

In the exemplary embodiment, information segment 93 including content information fields 93A and indexing information fields 93B is stored in M3U comment field format. Using the comment field format advantageously allows playlist 90 to remain compatible with other devices and software that utilize M3U playlist files.

FIG. 8 illustrates in flowchart form the steps of creating a playlist file in audio data player 10 in accordance with the present invention. In step 202, a set of audio data files to be included in playlist 90 is selected. In the exemplary embodiment, the audio data files are stored in data storage 32 and are selected by the user via user input 26 or by a software module directing generation of one or more playlist files to support browsing and navigation of the available audio data files in data storage 32. For example, playlist files may be generated for each of the content information fields 93A represented on the main sort-by menu shown in FIG. 5A, or a user playlist may be generated by user selection of particular audio data files stored in data storage 32.

In step 204, for each selected audio data file, a file pointer locating the associated audio data file relative to the location of playlist 90 is determined. For example, data storage 32 may include a folder structure for storing the audio files, thus the file pointer would include the necessary folder names and subfolder names as well as the file name for the associated data file. Alternatively, an absolute file pointer may be used that specifies device name and supports remote location of audio data files, for example, on a connected PC or the Internet.

In step 206, content information is located and read for each selected audio data file. In the exemplary embodiment, content information for MP3 files is included in ID3 tags. In step 208, one of the content information fields is selected for sorting playlist 90. For example, and as discussed above, a separate playlist file may be generated and sorted for each of the content information fields 93A displayed by the main sort-by menu shown in FIG. 5A. Additionally, further sorting levels may be used to further group and sort associated playlist records 92 within each previous sorting level. The content information fields 93A used for sorting may be selected by the user via user input 26 or by a software module for generating audio playlists 90. In step 210, DSP 12 sorts records 92 including file pointers 94 and content information fields 93, by the selected content information sorting field 93A.

In step 212, indexing information fields 93B are generated and content and indexing information 93 and file pointers 94 are formatted and stored in a playlist file. As discussed above for the method disclosed in FIG. 7, indexing information 93B provides for efficient and quick browsing and navigation of content information stored in playlist 90. In step 214, playlist file 90 is written to data storage 32.

In the exemplary embodiment, playlist files 90 having content and indexing information 93 stored in M3U comment fields are generated by a software application. The application, referred to as a profiler, may be implemented in a PC connected to audio data player 10, or as part of the software in non-PC-based audio data player 10. The profiler software locates each available audio data file stored in data stores 32 and reads its content information, for example, ID3 tag fields in MP3 files. The software profiler may then create several M3U playlists 90 including content and indexing information 93. Each playlist 90 may be sorted by one or more of the content information fields 93A, for example, title, artist, genre, album, and file name. Using one playlist 90 for each content information sorting field reduces the memory and processing power requirements of audio data player 10 required to display the available audio data files in specific orders and groupings.

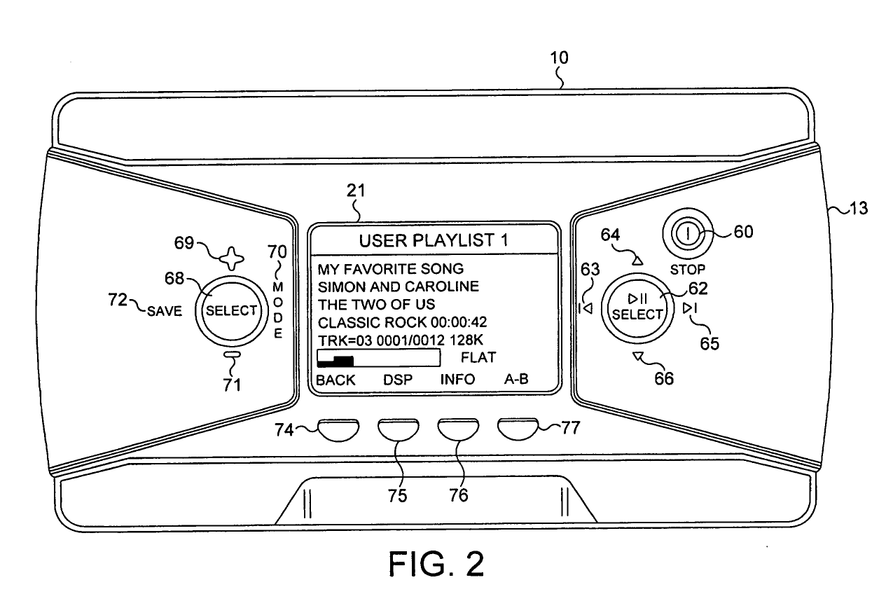

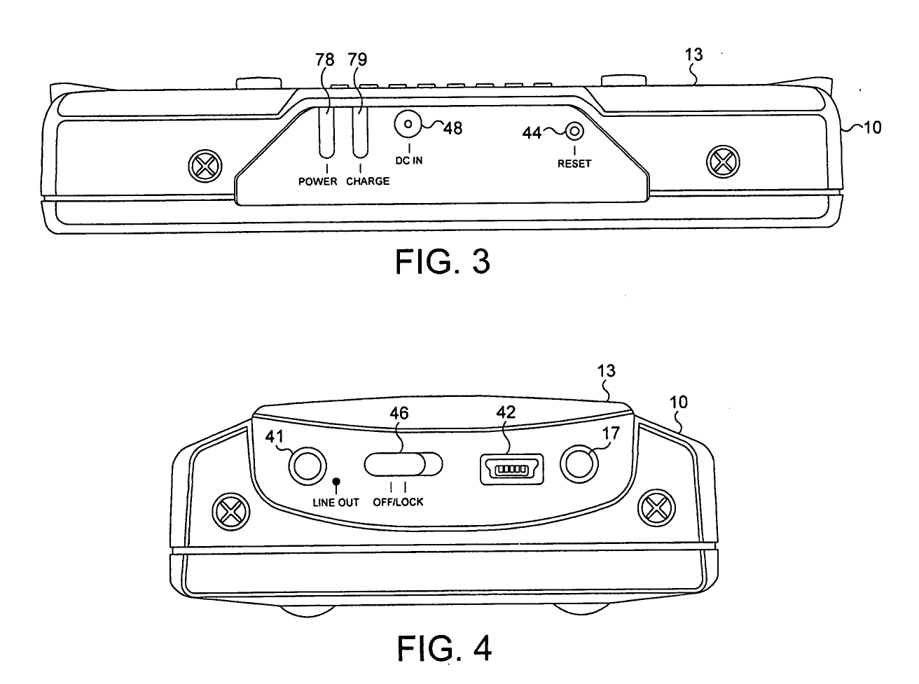

FIGS. 2-4 illustrate an exemplary embodiment of the displays, buttons, switches, indicators, and ports which may be disposed on housing 13 of audio data player 10. Referring to FIG. 2, user input 26 comprises a plurality of buttons 44 (FIG. 3), 46 (FIG. 4), and 60-77 disposed on housing 13 of audio data player 10 for allowing a user to sort and select particular audio data files for playback, and to control playback settings. User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes display 21 disposed on housing 13. Display 21 displays the audio data files and playlists stored in data storage 32, the function of soft keys 74-77, and various status information associated with audio data player 10, such as the playback status shown in FIG. 2 and the top-level menu shown in FIG. 5.

Referring again to FIG. 2, STOP/POWER button 60 allows the user to stop playback and to turn audio data player 10 on and off. PLAY/PAUSE button 62 allows the user to start playback and to pause playback. Left arrow button 63 allows a user to move a highlight left when using the menu, and to skip back to the previous audio data file or scan backward in the present audio data file when playing music. The right arrow button 65 allows the user to move a highlight right when using the menu, skip forward to the next audio data file, and scan forward in the current audio data file when playing music. Up arrow button 64 allows the user to move the highlight up when using the menu. Down arrow button 66 allows the user to move the highlight down when using the menu.

Referring still to FIG. 2, SELECT button 68 allows the user to select a highlighted item. Volume up button 69 increases the playback volume level for headphones 18 and volume down button 71 decreases the volume level. MODE button 70 allows the user to select a particular playback mode, including NORMAL, REPEAT, REPEAT ONE, REPEAT ALL, SHUFFLE, and REPEAT ALL SHUFFLE. SAVE button 72 allows a user to create a new playlist or add audio data files to an existing playlist. Soft keys 74-77 select the menu item that appears just above each button at the bottom of display 21.

Referring to FIG. 3, POWER indicator 78 lights when audio data player 10 is on. CHARGE indicator 79 lights when the power source 47 is charging. In the exemplary embodiment, power source 47 is a rechargeable battery pack. DC IN jack 48 provides 5 volt DC from an AC adapter to power audio data player 10 and recharge power source 47. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINE OUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

When the user selects a particular audio data file for playback via user input, DSP 12 loads the appropriate decoder file associated with the selected audio data file from data storage 32 into DSP memory 11. Referring again to FIG. 1, DSP 12 then streams the selected audio data file along buses 33 and 29 into buffer memory 25 as a skip-protection buffer.

After streaming of the selected audio data file begins, DSP 12 decodes the audio data file using an associated decoder file. Various decoder files may be stored in data storage 32 to allow audio player 10 to be adapted to process the various encoding formats associated with the audio data files stored in data storage 32. In effect, portable audio player 10 can be software upgraded, as necessary, by the decoder files stored in data storage 32 when the user selects a particular audio data file stored in data storage 32.

After powering up, DSP 12 of audio data player 10 loads the system configuration file from data storage 32. DSP 12 identifies the various file formats that need to be supported for the data files stored in data storage 32. The configuration file also includes information that equates the file extension of the audio data files with particular decoder files stored in data storage 32. If the configuration file is valid, DSP 12 reads the file attribute table stored in data storage 32 and causes display 21 to display a menu-driven listing of the file/folders stored in data storage 32.

Referring to FIG. 5A, the main menu displayed on display 21 allows the user to navigate and display audio data files according to groupings or identifying characteristics, such as, for example, artist, album, title, genre, playlist, and all audio data files. From the main menu, the user may operate user input 26, as described above, to navigate sorted lists and select a desired one of the displayed audio data files or playlists for playback.

When an audio data file or playlist is selected for playback, DSP 12 perform a number of steps, including several concurrent steps, to provide audio playback. First, DSP 12 identifies and transfers the corresponding decoder file from data storage 32 to DSP memory 11. For example, if the user selects an MP3 file, microcontroller 22 transfers the MP3 decoder file from data storage 32 to DSP memory 11. The MP3 decoder file is used to control the decoding operation of DSP 12.

DSP 12 begins streaming the selected audio data file from data storage 32 to buffer memory 25. DSP 12 uses the decoder file to decode and decrypt, if applicable, the audio data file in buffer memory 12 in accordance with the appropriate encoding format. The decoded audio data is provided to D/A converter 14 and headphone amp 16 and line out pre amp 40 for reproduction.

In the present embodiment, the necessary decoder files are stored in data storage 32 along with the audio data files. As such, audio player 10 may be updated to play different encoding formats by software updating of the DSP via decoder files stored along with the audio data files in data storage 32. Thus, audio data player 10 is capable of playing back data files encoded using a variety of encoding formats, including encoding formats that become available in the future.

During playback display, shown in FIG. 2, displays various information about the audio data file and the audio data player settings. For example, display 21 in FIG. 2 shows the file name, artist name, album title, genre, current track being played out of total files being played, volume level indication, elapsed play time of audio data file, playback mode indication, bit rate, and selected DSP mode selection.

In the exemplary embodiment, suitable DSP 12 include, but are not limited to, TMS320DA250 manufactured by Texas Instruments Inc., of Dallas, Tex. Associated with DSP 12 is memory 23, in this case, 48 KB of ROM, and buffer memory 25 comprising 8 MB of RAM, providing 7 minutes of buffered play time at 128 kbps and 14 minutes of buffered play time at 64 kbps. DSP 12 also includes associated memory 11, in this case 64 KB of RAM. Suitable hard drives for data storage 32 include, but are not limited to, Microdrive™ manufactured by IBM Corporation of Armonk, N.Y. A 10 GB hard drive, for example, provides approximately 150 hours of audio at MP3 bit-rate of 128 kbps, or 300 hours at a bit-rate of 64 kbps.

It will be apparent to those skilled in the art that although the present invention has been described in terms of an exemplary embodiment, modifications and changes may be made to the disclosed embodiment without departing from the essence of the invention. For example, although the present invention has been described with reference to data storage 32 that is fixedly disposed within audio player 10, the present invention may be implemented using flash memory, another fixed storage device, optical device, or a memory card that is adapted to be removably coupled to audio player 10, wherein the decoder program and audio data files are loaded onto the memory card by the music management software. Also, it is herein recognized that the present feature of loading the appropriate decoder programs and the audio data files may be implemented in the music management software using any one of a number of conventionally known programming methods, or combination of programming methods. Also, although the above is described in reference to an audio data player, the present invention may be extended to any portable data processing device, for example, video display devices, wherein the data may be encoded using one of a plurality of data encoding formats. Therefore, it is to be understood that the present invention is intended to cover all modifications as defined in the appended claims.

1. A computer-readable medium having stored thereon a data structure including a playlist record for each audio data file, each playlist record including a file pointer segment, wherein each playlist record including an information segment having a content information field descriptive of the content of the audio data file and including at least one indexing information field indicating the location of related playlist records, and the playlist file including a data header indicating a first content information field upon which the playlist records are sorted.

2. The data structure of claim 1, wherein the playlist records include an M3U format.

3. The data structure of claim 2, wherein said information segment includes an M3U comment format and said content information field includes an ID3 tag.

4. The data structure of claim 1, wherein the playlist records are sorted according to at least a second content information field.

5. The data structure of claim 1, wherein the location of said related playlist records is a relative location.

6. A method of adding to an audio data file playlist content and indexing information for each playlist record, comprising: locating content information descriptive of the content of each audio data file; determining for each playlist record indexing information providing the location of related playlist records; and formatting the content and indexing information for storage in the playlist.

7. The method of claim 6, comprising sorting the playlist according to the content information.

8. The method of claim 6, wherein the content information includes an ID3 tag, the playlist records include an M3U format, and the content and indexing information is stored in M3U comment field format.

9. In an audio data player having a user interface including an output device and a user input, a method of browsing audio data file content information by providing at least one playlist including at least a first and second record relating to audio data files available for playback, each record stored in a predetermined sequence and including a content and indexing information segment, comprising said content information including a field descriptive of the content of the related audio data file, and said indexing information having fields providing the location of related playlist records; outputting via the output device said content information field for at least a first record; receiving a playlist navigation signal from the user input; and in response to said playlist navigation signal, using at least one of said indexing information fields to locate and output said content information field of at least a second record, said second record related to said first record by said predetermined sequence and said navigation signal.

10. The method of claim 9, wherein said playlist records include an M3U format, said content and index information segment includes an M3U comment field format, and said content information field includes an ID3 tag.

11. The method of claim 9, wherein said predetermined sequence includes said playlist records sorted by at least one of said content information fields.

12. The method of claim 9, wherein the location of said related playlist records is a relative location.

13. An audio data player comprising a DSP (12) coupled with data storage capable of storing audio data files and playlist files the audio data files each having attributes descriptive of the audio content of each said audio data file; comprising the playlist files including records for each of at least a portion of the audio data files, said records in a predetermined order based on at least one said attribute; said records including a content information field storing said attributes of each said audio data file, and indexing information fields indicating the relative location of related playlist records; and the microcontroller having software capable of reading said playlist records and outputting a navigable list of at least a portion of said content information field according to said predetermined order.

14. The audio data player according to claim 13, comprising the DSP having software capable of generating playlist files.

15. The audio data player of claim 14, wherein said playlist file generating software is capable of sorting each playlist file according to said content information fields.

16. The audio data player of claim 15, wherein said playlist file generating software is capable of locating audio data files stored on the data storage device.

17. The audio data player of claim 16, wherein said playlist file generating software is capable of generating at least one additional audio data file playlist, said additional audio data file playlist sorted according to at least a second content information field.

18. The audio data player according to claim 13, wherein said attributes include an ID3 tag, and said playlist file records include an M3U format.

19. The audio data player according to claim 14, wherein said playlist file generating software is capable of determining file pointers locating each audio data file in the data storage; reading said attributes for each audio data file; formatting said attributes and said file pointers for storage in the audio data file playlist.
